(19) United States
(12) Patent Application Publication
(10) Pub. No.: US 2021/0119882 A1
(43) Pub. Date: Apr. 22, 2021

(54) METHODS AND APPARATUS TO DETERMINE TOPOLOGIES FOR NETWORKS

(71) Applicant: Intel Corporation, Santa Clara, CA (US)

(72) Inventors: Oner Orhan, San Jose, CA (US); Shilpa Talwar, Cupertino, CA (US); Marcel Nassar, Del Mar, CA (US); Hosein Nikopour, SAN JOSE, CA (US); Meryem Simsek, San Jose, CA (US); Oguz Elibol, Sunnyvale, CA (US)

(21) Appl. No.: 17/133,513

(22) Filed: Dec. 23, 2020

Related U.S. Application Data
(60) Provisional application No. 63/009,116, filed on Apr. 13, 2020.

(51) Int. Cl. H04L 12/24; H04L 5/00; G06N 20/00

(52) U.S. Cl. CPC H04L 41/16; G06N 20/00; H04L 5/0048; H04L 41/12

(57) ABSTRACT

Methods, apparatus, systems and articles of manufacture to determine topologies for networks are disclosed. An example a non-transitory computer readable medium comprises instructions that, when executed, cause a machine to at least: determine link capacities for a plurality of links between nodes of a network, determine a maximum number of children of the peer linked nodes, determine a maximum number of parents of the peer linked nodes, and utilize reinforcement learning to determine a subset of the plurality of links to be activated in the network based on the link capacities, the maximum number of children, and the maximum number of parents.

### RELATED APPLICATIONS

This patent claims the benefit of and priority to U.S. Provisional Patent Application Ser. No. 63/009,116, filed Apr. 13, 2020, entitled “REINFORCEMENT LEARNING-BASED NETWORK OPTIMIZATION VIA GRAPH NEURAL NETWORKS FOR ORAN AND INTEGRATED ACCESS AND BACKHAUL.” U.S. Provisional Patent Application Ser. No. 63/009,116 is hereby incorporated by reference herein in its entirety.

### FIELD OF THE DISCLOSURE

This disclosure relates generally to network topologies and, more particularly, to methods and apparatus determine topologies for networks.

### BACKGROUND

A mesh network is a network topology in which nodes (e.g., access points, stations, etc.) connect to other nodes and cooperate with one another to efficiently route data within the network. Mesh networks are commonly utilized with wireless networks to provide wireless network coverage to a large area without the need for each access point to connect to central infrastructure (e.g., in contrast to star or tree network topology). Because nodes can cooperate to transmit data, there may be many paths within a mesh network to travel from one point to another. The number of hops and the characteristics of the paths (e.g., bandwidth limitations, resource utilization, etc.) drives differences in the performance of each path. Some cellular networks employ mesh networking.

### BRIEF DESCRIPTION OF THE DRAWINGS

FIG. 1 is a block diagram of an example network environment.

FIG. 2 is a block diagram of an example implementation of the topology analyzer of FIG. 1.

FIG. 3 illustrates an example network topology.

FIG. 4 illustrates example states of a network environment.

FIG. 5 is a flowcharts representative of example machine readable instructions that may be executed to implement the example topology analyzer of FIGS. 1 and/or 2.

FIGS. 6-8 illustrate example cumulative distribution functions for network topologies.

FIG. 9 illustrates an overview of an edge cloud configuration for edge computing.

FIG. 10 illustrates operational layers among endpoints, an edge cloud, and cloud computing environments.

FIG. 11 illustrates an example approach for networking and services in an edge computing system.

FIG. 12 is a block diagram of an example processing platform structured to execute the example machine readable instructions of FIG. 5 to implement the example topology analyzer of FIGS. 1 and/or 2.

FIG. 13 is a block diagram of an example software distribution platform to distribute software (e.g., software corresponding to the example machine readable instructions of FIG. 5) to client devices such as consumers (e.g., for license, sale and/or use), retailers (e.g., for sale, re-sale, license, and/or sub-license), and/or original equipment manufacturers (OEMs) (e.g., for inclusion in products to be distributed to, for example, retailers and/or to direct buy customers).

The figures are not to scale. In general, the same reference numbers will be used throughout the drawing(s) and accompanying written description to refer to the same or like parts. As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

### DETAILED DESCRIPTION

Due the nature of mesh networks and the many possible topologies (e.g., network traffic paths through the network), it is desirable to identify an optimal topology (or one of many optimal) for a given network. Methods and apparatus disclosed herein utilize reinforcement learning to determine a proposed optimal topology. In some examples, the reinforcement learning attempts to define an optimal topology that maximizes the network capacity (e.g., maximum data rate for traffic flowing through the network). According to the examples disclosed herein, the reinforcement learning is constrained by a first limit on a number of parent nodes and a second limit on a number of child nodes for any given node. In some disclosed examples, the reinforcement learning is based on capacities of each node and each link.

The third-generation partnership project (3GPP) is defining an integrated access and backhaul (IAB) architecture for the fifth generation (5G) cellular networks, in which the same infrastructure and spectral resources are used for both the access and the backhaul. In 3GPP, two types of IAB base stations have been defined: IAB donor and IAB node. A donor IAB, connected to internet backbone, provides wireless backhaul to multiple IAB nodes. Each IAB node provides wireless access to user devices and wirelessly backhauls traffic to other IAB nodes.

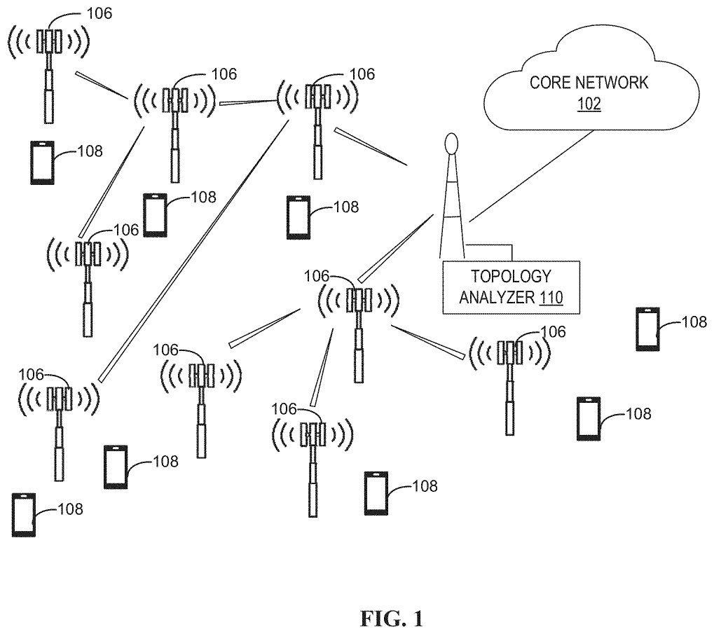

FIG. 1 is a block diagram of an example network environment 100. The example network environment 100 includes an example core network 102, an example donor access point 104, multiple example node access points 106, multiple example client devices 108, and an example topology analyzer 110 coupled to the donor access point 104.

The example network environment 100 may be implemented according to the 3GPP 5G cellular IAB architecture. Alternatively, the example network environment 100 may be any other type of mesh network (e.g., a WiFi access network, an Internet of Things (IoT) mesh network, etc.).

The example core network 102 is the internet. Alternatively, the core network 102 may be any other network or type of network to which the donor access point 104 may be communicatively coupled. For example, the core network 102 may be a wide area network, a local area network, a wireless network, a wired network, etc.

The example donor access point 104 communicatively couples the core network 102 with the remainder of the network (e.g., the node access points 106). According to the illustrated example, the donor access point 104 is directly coupled (e.g., directly wirelessly coupled) with a subset of the node access points 106 and others of the node access points 106 are indirectly coupled to the donor access point 104 (e.g., coupled via one or more intermedia node access points 106). While the example network environment 100 includes a single donor access point 104, a network environment may include multiple donor access points that each provide access to one or more node access points. While the example donor access point 104 is an IAB donor, the donor access point 104 may operate according to any other mesh network architecture.

According to the illustrated example, in addition to coupling the node access points 106 to the core network 102, the donor access point 104 is also a cellular access point to which the client devices 108 may connect. Alternatively, the donor access point 104 may not support connections from the client devices 108.

The example node access points 106 are cellular access points to which the client devices 108 may connect to access the core network 102. For example, the node access points 106 may support millimeter wave spectrum cellular connections or any other type of connection. Alternatively, the node access points 106 may be any other type of access points to which the client devices 108 may connect (e.g., a WiFi access point, a short-range wireless access point, etc.). According to the illustrated example, the node access points are IAB nodes that cooperate to provide access to the donor access point 104. Alternatively, the node access points 106 may operate according to any other type of mesh network architecture.

The example node access points 106 determine how traffic will flow through the example network environment 100 according to a routing table at the respective node access points 106. For example, the routing table may define which links a particular one of the node access points 106 is to utilize in transmitting traffic through the network. The example routing table identifies a next hop identifier indicating a location to which received traffic should be routed next (e.g., a backhaul adaptation protocol (BAP) routing identifier).

The example client devices 108 are cellular-enabled user computing devices. Alternatively, the client devices 108 may be any other type of computing devices to be communicatively coupled to the core network 102 via the node access points 106 and the donor access point 104.

In operation of the example network environment 100, when one of the client devices 108 wants to reach the core network 102 (e.g., to retrieve a website), the one of the client devices 108 communicates with a first one of the node access points 106. The first one of the node access points 106 consults its routing table to determine a next hop for the request (e.g., a second one of the node access points 106) and the traffic is routed to that destination. The second one of the access points receiving that traffic consults its routing table to determine a next hop for the request (e.g., the donor access point 104) and the traffic is routed to that destination. The donor access points 104 then routes the request to the core network 102.

To determine an optimized topology identifying the links to be utilized for transmitting traffic among the node access points 106 and the donor access point 104, the example environment 100 includes the example topology analyzer 110. The example topology analyzer utilizes reinforcement learning (RL) and graph embedding to identify a topology that maximizes the data capacity of the network. As used herein, the maximizing of the data capacity is a goal that may not be objectively reached. For example, a topology may maximize data capacity within the constraints of the analysis (e.g., the number of iterations of a learning analysis) while not reaching a theoretical maximum data capacity. This disclosure covers operations that seek to maximize data capacity and other objective functions even if those operations do not ultimately achieve the theoretical maximum.

The example topology analyzer 110 includes a neural processor to perform the reinforcement learning. A neural processor is a specialized circuit that implements control and arithmetic logic executing machine learning algorithms such as neural networks. The neural processor may be referred to as a tensor processing unit (TPU), a neural network processor (NNP), an intelligence processing unit (IPU), a vision processing unit (VPU), a graph processing unit (GPU), etc. For example, the donor access point 104 may include a neural processor to analyze the network environment 100 and determine an optimized topology. Alternatively, one or more of the node access points 106 may include the topology analyzer 110. For example, one or more of the node access points 106 may include a neural processor for implementing the methods and apparatus disclosed herein. In some examples, the topology analyzer 110 may be implemented within a controller of the donor access point 104 and/or the node access points 106. For example, the example neural processor may be embedded on a controller motherboard within a chassis and/or may be included in an adapter card that may be installed within a chassis of a controller. For example, the donor access point 104 and/or the node access points 106 may include a transceiver, a router, a switch, a firewall, etc. with associated controller(s) that may include a neural processor. Alternatively, the topology analyzer 110 may be implemented within the existing controller/processor of such hardware.

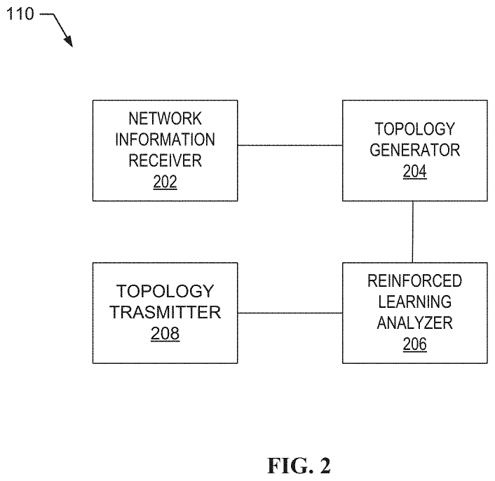

FIG. 2 is a block diagram of an example implementation of the topology analyzer 110 of FIG. 1. The example topology analyzer 110 includes an example network information receiver 202, an example topology generator 204, an example reinforced learning analyzer 206, and an example topology transmitter 208.

The example network information receiver 202 receives information about the network environment 100 and parameters of the analysis to be performed. For example, the network information receiver 202 receives information input by a user that identifies the peer linked nodes of the example network environment 100. For example, the peer linked nodes access points that are associated with the donor access point 104 (e.g., represented by n₀) may be represented by [symbol] ={n₁, n₂, . . . , n_{|N|}}. The example information received by the network information receiver 202 includes a maximum number of parents (e.g., 1, 2, 3, 4, 5, etc.) and a maximum number of children (e.g., 1, 2, 3, 4, 5, etc.) that can be associated with the node access points 106. For example, the maximum values may be input by a user that is familiar with the hardware limitations of the node access points 106. For example, each of the node access points 106, nᵢ have a set of parents P(nᵢ)∈ [symbol] ∪nₒ and a set of children [symbol] (nᵢ)∈ [symbol] . The maximum number of parents is represented by Pₘₐₓ and the maximum number of children is represented by Cₘₐₓ.

The example network information receiver 202 may obtain additional information by analyzing the example network environment 100. For example, the network information receiver 202 may gather capability and capacity information for the node access points 106. For example, the topology analyzer may determine capabilities of the node access points using reference signal received power (RSRP) measurements from the node access points 106 and the donor access point 104.

The example topology generator 204 determines topologies and topology information (e.g., capacities) for the information received by the network information receiver 202. For example, a set of all possible topologies [symbol] for a given number of nodes | [symbol] |+1 (e.g., the number of node access points 106 plus the number of donor access points 104). The topology generator can represent each topology [symbol] ₘ∈ [symbol] by an adjacency matrix [symbol] . In the example adjacency matrix, if [symbol] (i, j)=1, there is an active link from nᵢ to nⱼ (e.g., a connection to be utilized according to a routing table of the corresponding one of the node access points 106), otherwise, there is no active link between these nodes. A set of potential parent nodes [symbol] may be a set of nodes in which have less than Cₘₐₓ children (e.g., could be a parent for a node because they have the capacity for another child). A set of potential children nodes [symbol] may be a set of nodes which have less than Pₘₐₓ parents (e.g., could be a child of a node because they have the capacity for another parent).

The topology generator 204 determines a link capacity between nodes nᵢ and nⱼ, i≠j, as follows:

$${c}_{{n}_{i} , {n}_{j}} = {log}_{2} ( 1 + \frac{{Z}_{{n}_{i} , {n}_{j}}}{{σ}^{2}} )$$

where σ² is additive white Gaussian noise power and Zₙ_{ᵢ}_{,n}_{ⱼ} is received signal power between nodes nᵢ and nⱼ. The topology generator 204 determines a node score vₙ_{ᵢ} for each node nᵢ as follows:

$${v}_{{n}_{i}} = {\sum }_{{n}_{j} ∈ P ( {n}_{i} )} min \{ {v}_{{n}_{j}} , {c}_{{n}_{j} , {n}_{i}} \}$$

Here, the node score vₙ_{ᵢ} represents a sum of minimum capacities of the paths from the donor access point 104, n₀ to a given node access point 106, node nᵢ.

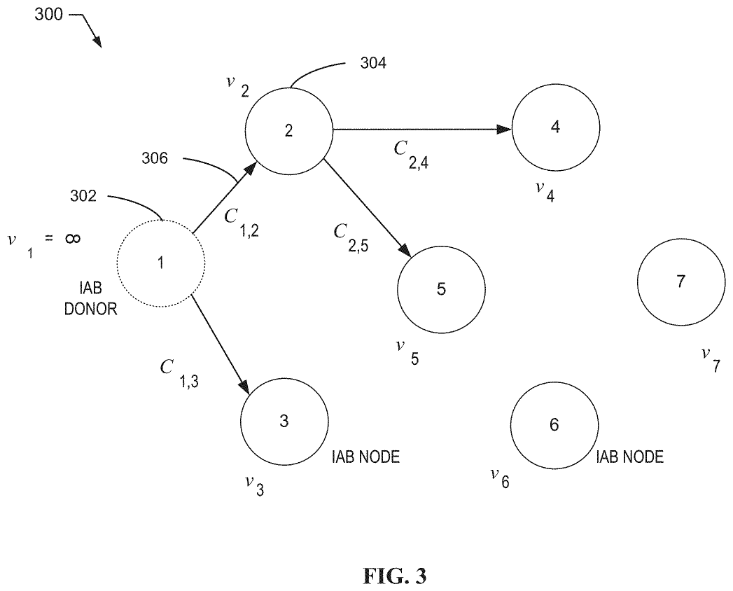

An example network topology 300 is illustrated in FIG. 3. As shown in the example, the node score of an example donor access point 302 is infinite because the donor access point 302 does not have any parents. The node score of an example node access point 304 is represented by v₂ and a link capacity 306 between the donor access point 302 and the node access point 304 is represented by c_{1,2}.

Returning to FIG. 2, the topology generator 204 determines a network capacity as follows:

$$u ( 𝒯 ) = {\sum }_{{n}_{j} ∈ 𝒩} {v}_{{n}_{i}}$$

Thus, the topology for a network environment (e.g., the example network environment 100) may be stated as:

$${𝒯}^{*} = arg {max}_{𝒯} u ( 𝒯 )$$

The example reinforced learning analyzer 206 utilizes reinforcement learning (e.g., deep reinforcement learning) to attempt to identify the optimal topology that maximizes the network capacity of the example network environment 100. While the reinforced learning analyzer 206 attempts to identify the topology associated with the maximum network capacity or the optimal topology, the reinforced learning analyzer may simply identify a best topology from a subset of theoretically possible topologies. For example, computational limitations may limit the ability to find the ultimately optimal solution and a best identified (e.g., most optimal topology of all topologies analyzed) may be identified. For example, deep reinforcement learning may be perform a set number of iterations and identify the best topology identified during the set number of iterations, wherein allowing more iterations will cause the computation to take longer but may identify a more optimal topology.

To perform the reinforcement learning, the reinforced learning analyzer 206 defines a possible state sₜ as a topology of network in [symbol] ₘ∈ [symbol] . A start state s₀ is a network without links between the peer linked nodes (i.e., [symbol] =0) and a terminal state s_{T} exists in which all the peer linked nodes nᵢ∈ [symbol] are connected to the network such that there is no remaining link activation possible between the peer linked nodes to increase the network capacity. Furthermore, the reinforced learning analyzer 206 defines an action aₜ as activating a link between two nodes nᵢ∈ [symbol] and nⱼ∈ [symbol] at state sₜ. Once a link is activated between the peer linked nodes nᵢ and nⱼ, the corresponding topology is updated to

[symbol]

ₙ← [symbol] ₘ∪(nᵢ,nⱼ)

(i.e., the next state sₜ₊₁= [symbol] ₙ is achieved). The set of potential parents and children are then updated to [symbol] and [symbol] . Further, the reinforced learning analyzer 206 considers a reward r(sₜ; a; sₜ₊₁) is given by u(sₜ₊₁)−u(sₜ) (e.g., the increase (or decrease) in network capacity for moving from the current state to the next state).

To perform reinforcement learning, the reinforced learning analyzer 206 defines a policy (e.g., a strategy that is utilized to pursue the goal of optimization) as π(aₜ|sₜ), which is a probability distribution of action aₜ at state sₜ.

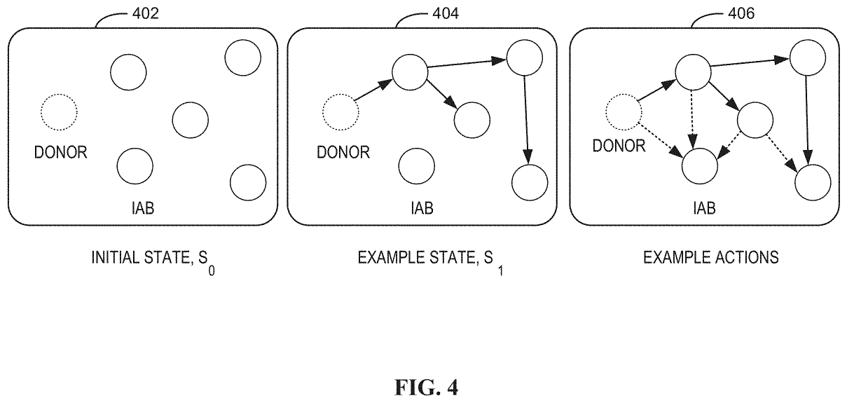

For example, FIG. 4 illustrates example states of a network environment. According to the illustrated example, a first illustration 402 represents an initial state s₀ in which there are no connections among nodes and a second illustration 404 represents another state s₁ in which a number of links are included among nodes. The example third illustration 406 illustrates that the addition of a link is an action aₜ.

Returning to FIG. 2, the example reinforced learning analyzer 206 utilizes graph embedding to perform its optimization analysis. The example reinforced learning analyzer 206 utilizes Q-learning, which finds an optimal policy for any finite Markov decision process (FMDP). The example reinforced learning analyzer 206 defines q(s; a; w) function which considers graph structure of a topology at state s with action a and weights w. In order to extract structure of graph, the reinforced learning analyzer 206 utilizes a node embedding μₙ_{ᵢ} for each node which considers neighboring nodes, node and edge features and long-range interactions between nodes. Thus, the node embedding represents the features of the node in a manner that can be analyzed by the reinforced learning analyzer 206. For example, the features may be represented by the example node score vₙ_{ᵢ} and the example capacity between nodes cₙ_{ᵢ}_{,n}_{ⱼ} at each node and edge/connection, respectively. For a first iteration of the learning, the reinforced learning analyzer 206 determines a node embeddings as:

μₙ_{ᵢ}⁽⁰⁾←f(w₁vₙ_{ᵢ}+W₄Σₙ_{ⱼ}_{∈P(n}_{ᵢ}₎f(w₅cₙ_{ⱼ}_{,n}_{ᵢ})+W₆Σₙ_{ⱼ}_{∈C(n}_{ᵢ}₎f(w₇cₙ_{ᵢ}_{,n}_{ⱼ})),

where weights are wᵢ∈R^{p×1}, i=1, 5, 7 and Wⱼ∈R^{p×p}, j=4,6 and

μₙ_{ᵢ}^{(m)}←f(w₁vₙ_{ᵢ}+W₄Σₙ_{ⱼ}_{∈P(n}_{ᵢ}₎f(w₅Cₙ_{ⱼ}_{,n}_{ᵢ})+W₆Σₙ_{ⱼ}_{∈C(n}_{ᵢ}₎f(w₇cₙ_{ᵢ}_{,n}_{ⱼ})+W₂Σₙ_{ⱼ}_{∈P(n}_{ᵢ}₎μₙ_{ⱼ}^{(m-1)}+W₃Σₙ_{ⱼ}_{∈C(n}_{ᵢ}₎μₙ_{ⱼ}^{(m-1)}),

where Wⱼ∈ [symbol] ^{p×p}, j=2,3. The reinforced learning analyzer 206 applies the foregoing update up to M times. At the final layer, the reinforced learning analyzer 206 computes a Q-function as follows:

$$q ( s ; a ; w ) = {w}_{10}^{T} f ( [ {W}_{8} \sum {μ}_{{n}_{i}}^{( M )} , {W}_{9} {μ}_{{n}_{k}}^{( M )} ] )$$

where w₁₀∈ [symbol] ^{p×1}, W₈∈ [symbol] ^{p×p}, Wₚ∈ [symbol] ^{p×p}, wherein R^{p×1} is a column vector of real numbers with size p, R^{p×p} is a matrix of real numbers where the size of the matrix is p rows by p columns, and where nₖ is a child of new link corresponding to action a.

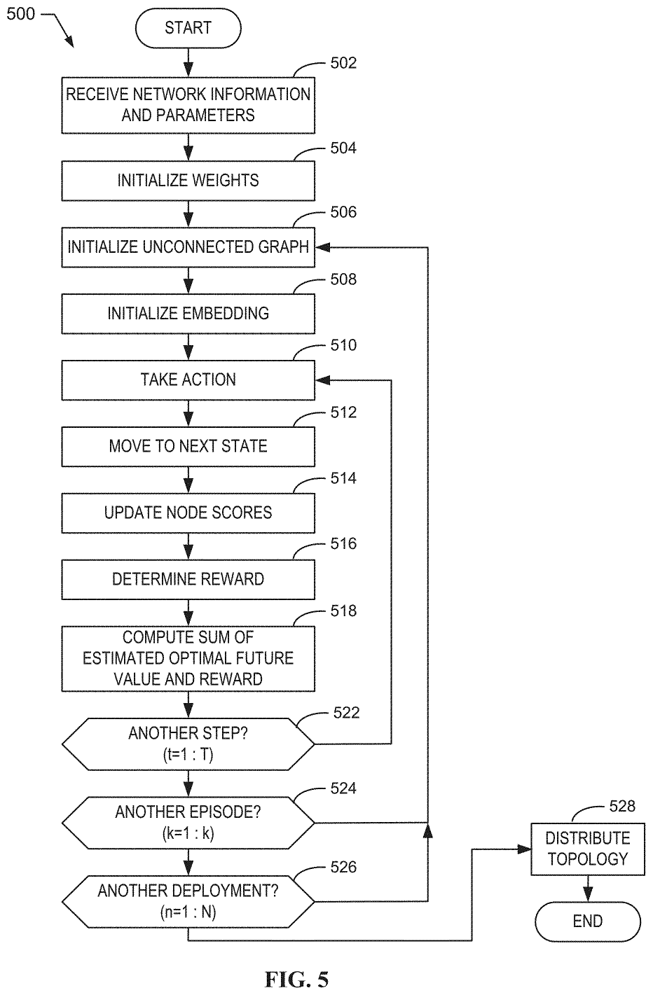

The reinforcement learning analyzer 206 trains weights according to the process illustrated in FIG. 5, which is described in further detail below.

Once the reinforcement learning analyzer 206 completes the reinforcement learning process to identify an optimal topology (e.g., set of connections among nodes), the topology is provided to the example topology transmitter 208.

The example topology transmitter 208 distributes information about the topology to the donor access points 104 and the node access points 106. For example, the topology transmitter 208 transmits an indication to each node indicating the parent nodes to be stored in the routing table of the peer linked nodes. In some examples, the transmitted information includes information to configure a first routing table for the uplink direction and a second routing table for the downlink direction. For example, the routing table for uplink information may identify the parent nodes and the information for the downlink direction may identify the child nodes.

While an example manner of implementing the topology analyzer 110 of FIG. 1 is illustrated in FIG. 2, one or more of the elements, processes and/or devices illustrated in FIG. 2 may be combined, divided, re-arranged, omitted, eliminated and/or implemented in any other way. Further, the example network information receiver 202, the example topology generator 204, the example reinforced learning analyzer 206, the example topology transmitter 208, and/or, more generally, the example topology analyzer 110 of FIG. 2 may be implemented by hardware, software, firmware and/or any combination of hardware, software and/or firmware. Thus, for example, any of the example network information receiver 202, the example topology generator 204, the example reinforced learning analyzer 206, the example topology transmitter 208, and/or, more generally, the example topology analyzer 110 of FIG. 2 could be implemented by one or more analog or digital circuit(s), logic circuits, programmable processor(s), programmable controller(s), graphics processing unit(s) (GPU(s)), digital signal processor(s) (DSP(s)), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example network information receiver 202, the example topology generator 204, the example reinforced learning analyzer 206, and/or the example topology transmitter 208 is/are hereby expressly defined to include a non-transitory computer readable storage device or storage disk such as a memory, a digital versatile disk (DVD), a compact disk (CD), a Blu-ray disk, etc. including the software and/or firmware. Further still, the example topology analyzer 110 of FIG. 1 may include one or more elements, processes and/or devices in addition to, or instead of, those illustrated in FIG. 2, and/or may include more than one of any or all of the illustrated elements, processes and devices. As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

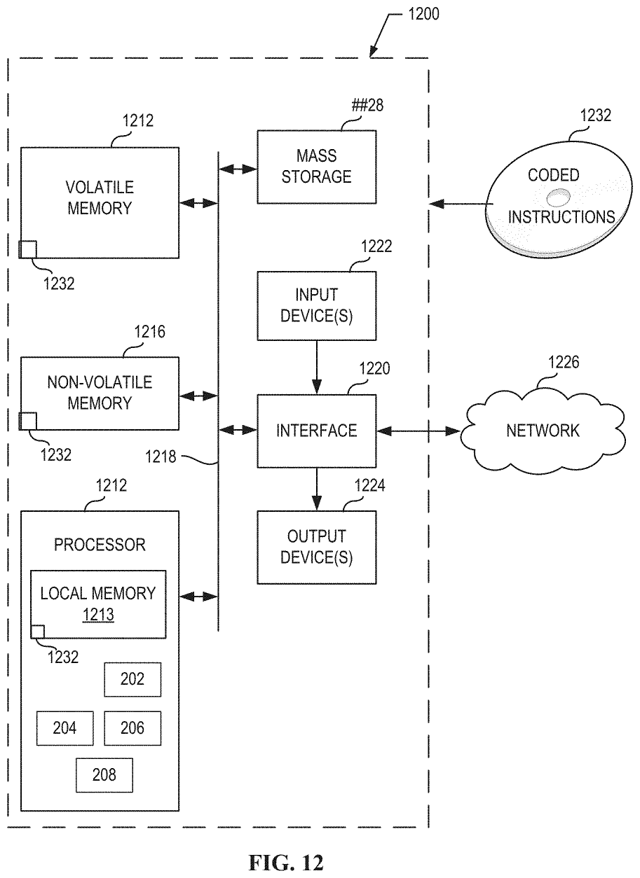

A flowchart representative of example hardware logic, machine readable instructions, hardware implemented state machines, and/or any combination thereof for implementing the topology analyzer 110 of FIGS. 1 and/or 2 is shown in FIG. 5. The machine readable instructions may be one or more executable programs or portion(s) of an executable program for execution by a computer processor and/or processor circuitry, such as the processor 1212 shown in the example processor platform 1200 discussed below in connection with FIG. 12. The program may be embodied in software stored on a non-transitory computer readable storage medium such as a CD-ROM, a floppy disk, a hard drive, a DVD, a Blu-ray disk, or a memory associated with the processor 1212, but the entire program and/or parts thereof could alternatively be executed by a device other than the processor 1212 and/or embodied in firmware or dedicated hardware. Further, although the example program is described with reference to the flowchart illustrated in FIG. 5, many other methods of implementing the example topology analyzer 110 may alternatively be used. For example, the order of execution of the blocks may be changed, and/or some of the blocks described may be changed, eliminated, or combined. Additionally or alternatively, any or all of the blocks may be implemented by one or more hardware circuits (e.g., discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more devices (e.g., a multi-core processor in a single machine, multiple processors distributed across a server rack, etc.).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc. in order to make them directly readable, interpretable, and/or executable by a computing device and/or other machine. For example, the machine readable instructions may be stored in multiple parts, which are individually compressed, encrypted, and stored on separate computing devices, wherein the parts when decrypted, decompressed, and combined form a set of executable instructions that implement one or more functions that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc. in order to execute the instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Assembly, etc.

As mentioned above, the example process of FIG. 5 may be implemented using executable instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc. may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, and (7) A with B and with C. As used herein in the context of describing structures, components, items, objects and/or things, the phrase “at least one of A and B” is intended to refer to implementations including any of (1) at least one A, (2) at least one B, and (3) at least one A and at least one B. Similarly, as used herein in the context of describing structures, components, items, objects and/or things, the phrase “at least one of A or B” is intended to refer to implementations including any of (1) at least one A, (2) at least one B, and (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, and (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, and (3) at least one A and at least one B.

As used herein, singular references (e.g., “a”, “an”, “first”, “second”, etc.) do not exclude a plurality. The term “a” or “an” entity, as used herein, refers to one or more of that entity. The terms “a” (or “an”), “one or more”, and “at least one” can be used interchangeably herein. Furthermore, although individually listed, a plurality of means, elements or method actions may be implemented by, e.g., a single unit or processor. Additionally, although individual features may be included in different examples or claims, these may possibly be combined, and the inclusion in different examples or claims does not imply that a combination of features is not feasible and/or advantageous.

The program 500 of FIG. 5 begins when the example network information receiver 202 receives information and parameters about a network environment (e.g., the example network environment 100) (block 502). For example, the information may identify the number of nodes within the network, link capacities between nodes (e.g., based on measurements such as received signal strength indicators like reference signal received power), etc. The parameters may include a maximum number of children for nodes, a maximum node of parents for nodes, etc. The example reinforced learning analyzer 204 initializes weights for reinforcement learning (block 504). According to the illustrated example, the weights are initialized with random values. For example, in relation to formulas described in conjunction with FIG. 2, the weights Wᵢ and wⱼ, i=1, 5, 7, 8, 9 and j=2, 3, 4, 6, 10 are randomly initialized.

The example topology generator 204 initializes the unconnected graph for initial state s₀ (block 506). The example topology generator 204 initializes the node embedding as μₙ_{ᵢ}⁽⁰⁾=0 (block 508).

The example reinforced learning analyzer 206 takes an action for the current step (e.g., the initial step) aₜ·π(aₜ|sₜ) (block 510). The example reinforced learning analyzer 206 then moves to the next state (sₜ₊₁← [symbol] ₘ∪(nᵢ, nⱼ)) (block 512). The reinforced learning analyzer 206 updates the node scores vₙ_{ᵢ} (block 514). The reinforced learning analyzer 206 determines the reward for the action that moves to the next state (r(sₜ; a; sₜ₊₁)=u(sₜ₊₁)−u(sₜ)) (block 516). The reinforced learning analyzer 206 then computes an estimated value of the current state (block 518) and action. For example, the estimation may be computed as

$$y = γ {max}_{{a}_{t + 1}} q ( {s}_{t + 1} , {a}_{t + 1} , w ) + r ( {s}_{t} ; a ; {s}_{t + 1} ) ,$$

where γ is a discount factor. For example, γ may be a value between 0 and 1 that may be used to determine the relative importance of future rewards. A γ of 0 will make the agent “myopic” (or short-sighted) by only considering current rewards, while a factor approaching 1 will make it strive for a long-term high reward.

The reinforced learning analyzer 206 then updates the weights of the reinforced learning process based on the state information (block 520). For example, the weights may be updated as:

Wᵢ←Wᵢ+α(y−q(sₜ,aₜ,w))∇_{w}_{ᵢ}q(sₜ,aₜ,w),i=1,5,7

wᵢ←wᵢ+α(y−q(sₜ,aₜ,w))∇_{w}_{ᵢ}q(sₜ,aₜ,w),i=2,3,4,6,8

using ϵ-greedy policy

$$π ( {a}_{t + 1} \vert {s}_{t + 1} ) = \{ \begin{matrix}random edge ( {n}_{i} , {n}_{j} ) , & w \cdot p \cdot ϵ \\ {max}_{{a}_{t + 1}} q ( {s}_{t + 1} , {a}_{t + 1} , w ) & o \cdot w\end{matrix} .$$

The reinforced learning analyzer 206 then determines if there is another step (block 522). For example, the reinforced learning analyzer 206 determines if the process has reached an input number of embedding iterations (e.g., T embedding iterations) as received in block 502). T represents the time that terminal state has been reached (e.g., terminal state is when all the peer linked nodes are connected in the network). Therefore, T depends on the particular deployment scenario. If there are additional steps, control returns to block 510 to iterate the next step.

When there are no further steps, the reinforced learning analyzer 206 determines if there are further episodes to process (block 524). For example, the reinforced learning analyzer 206 determines if the process has reached an input number of episodes K. For example, the process may be iterated through episodes until a terminal state is reached (e.g., there are no expected future rewards of further states). N and K may be selected to control performance of a resulting algorithm. For example, N and K may be selected based on trial and error.

If there are additional episodes, the reinforced learning analyzer 206 moves to the next episode (k) and control returns to block 506.

When there are no further episodes, the reinforced learning analyzer 206 determines if there are further deployments to be analyzed (block 526). When there are further deployments to be analyzed, the reinforced learning analyzer moves to the next deployment (n) and control returns to block 506.

When there are no further deployments, the topology transmitter 208 transmits the information about the activated links to the example donor access point 104 and/or the node access points 106 of the example network environment 100 (block 528). The process 500 is then complete.

The example reinforced learning analyzer 206 may implement the reinforcement learning algorithm:

| | |
|---|---|
| 1. | Randomly initialize Wᵢ and wⱼ, i = 1, 5, 7, 8, 9 and j = 2, 3, 4, 6, |
| | 10 |
| 2. | Define number of deployment N, episodes K, and embedding itera- |
| | tions T |
| 3. | For deployment n = 1: N do |
| 4. | For episode k = 1: K do: |
| 5. | Initialize s₀ unconnected graph |
| 6. | Initialize embedding μₙ_{ᵢ}⁽⁰⁾ = 0 |
| 7. | For step t = 1: T do: |
| 8. | Take action aₜ~π(aₜ\|sₜ) |
| 9. | Move to next state sₜ₊₁ ← [symbol] ∪ (nᵢ, nⱼ) |
| 10. | Update node scores vₙ_{ᵢ} |
| 11. | Observe reward r(sₜ; a; sₜ₊₁) = u(sₜ₊₁) − u(sₜ). |
| 12. | $Compute y = γ {max}_{{a}_{t + 1}} q ( {s}_{t + 1} , {a}_{t + 1} , w ) + r ( {s}_{t} ; a ; {s}_{t + 1} )$ |
| 13. | Update parameters: |
| | Wᵢ ← Wᵢ + α(y − q(sₜ, aₜ, w))∇_{W}_{ᵢ}q(sₜ, aₜ, w), i = 1, 5, 7 |
| | wᵢ ← wᵢ + α(y − q(sₜ, aₜ, w))∇_{w}_{ᵢ}q(sₜ, aₜ, w), i = 2, 3, 4, 6, 8 |
| | Use ϵ-greedy policy |
| | $π ( {a}_{t + 1} \vert {s}_{t + 1} ) = \{ \begin{matrix}random edge ( {n}_{i} , {n}_{j} ) , w . p . ϵ \\ {max}_{{a}_{t + 1}} q ( {s}_{t + 1} , {a}_{t + 1} , w ) o . w .\end{matrix}$ |

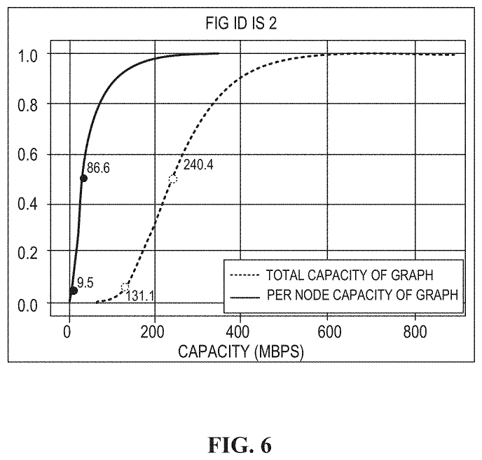

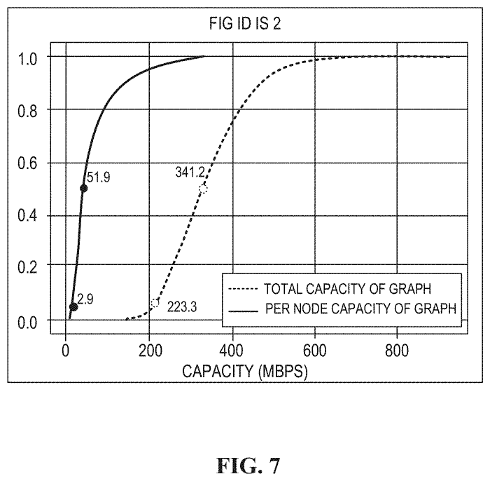

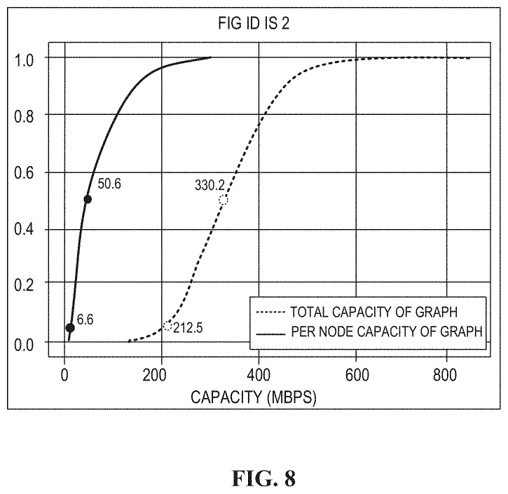

By way of example, the methods and apparatus disclosed herein may be applied to a 3GPP cellular deployment for a base stations of IAB nodes and user nodes. For example, the base stations may be deployed in hexagonal areas representing their coverage. Each base station has 3 sectors covering 120 degrees. In each sector, there is there is a uniformly deployed fixed number of IAB nodes and user nodes. Such an example may include a line-of-sight channel at 28 GHz carrier frequency. The methods and apparatus disclosed herein may be utilized with an ϵ-greedy Q-learning to learn weights. The Q-function may be trained over 5000 different topologies with 6 IAB nodes (e.g., one IAB donor and 5 IAB nodes). According to the example, the parameters may be set as Pₘₐₓ=1 and Cₘₐₓ=2. For such an example, cumulative distribution functions (cdf) for a random sequence policy are shown in illustration 600 of FIG. 6. FIG. 7 includes an illustration 700 identifies the cdf for a global optimal dynamic programming algorithm. Finally, illustration 800 of FIG. 8 illustrates the cdf for a reinforcement-based network topology formation in accordance with the methods and apparatus disclosed herein. As shown in the following table, the reinforcement-based approach performs 38% better than random sequencing algorithm and only 2.5% worse than the global optimal dynamic programming, while the reinforcement learning approach in accordance with the methods and apparatus disclosed herein is lightweight enough to be performed using computing resources available at, for example, the donor access point 104 and/or the peer linked nodes access points 106.

| | Per node | Total |
|---|---|---|
| | capacity | Capacity |
| Algorithm | (normalized) | (normalized) |
| Random | 0.645 | 0.7 |
| (6 IAB nodes) | | |
| Dynamic | 1 | 1 |
| programming | | |
| (6 IAB nodes) | | |
| Reinforced | 0.968 | 0.975 |
| learning | | |
| (6 IAB nodes) | | |

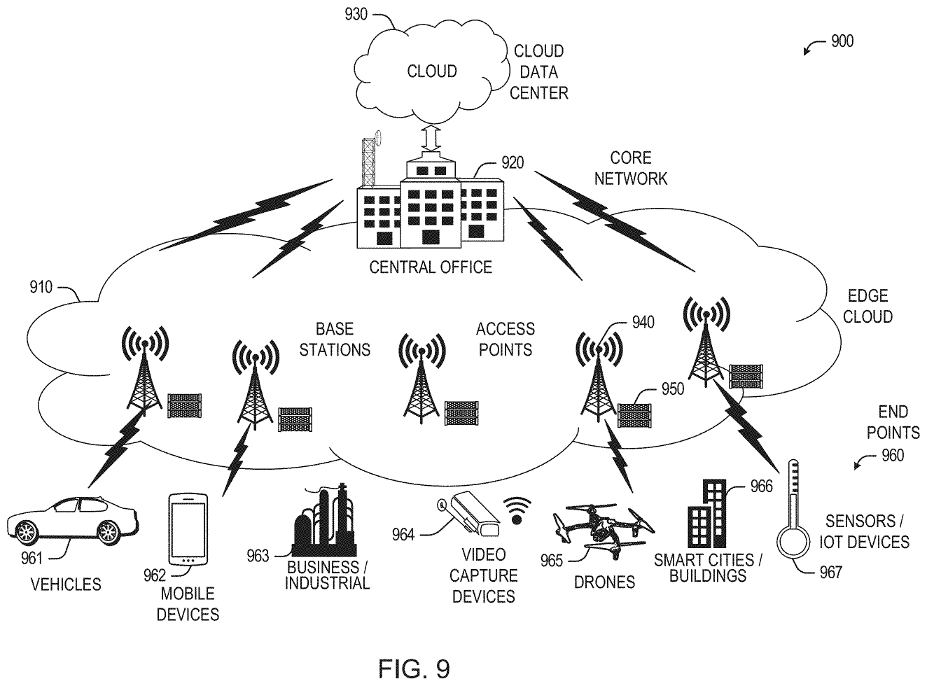

FIGS. 9-11 illustrate edge computing environments that may be utilized in conjunction with the methods and apparatus disclosed herein. For example, the network environment 100 may by employed within any of the networks described in FIGS. 9-11.

FIG. 9 is a block diagram 900 showing an overview of a configuration for edge computing, which includes a layer of processing referred to in many of the following examples as an “edge cloud”. As shown, the edge cloud 910 is co-located at an edge location, such as an access point or base station 940, a local processing hub 950, or a central office 920, and thus may include multiple entities, devices, and equipment instances. The edge cloud 910 is located much closer to the endpoint (consumer and producer) data sources 960 (e.g., autonomous vehicles 961, user equipment 962, business and industrial equipment 963, video capture devices 964, drones 965, smart cities and building devices 966, sensors and IoT devices 967, etc.) than the cloud data center 930. Compute, memory, and storage resources which are offered at the edges in the edge cloud 910 are critical to providing ultra-low latency response times for services and functions used by the endpoint data sources 960 as well as reduce network backhaul traffic from the edge cloud 910 toward cloud data center 930 thus improving energy consumption and overall network usages among other benefits.

Compute, memory, and storage are scarce resources, and generally decrease depending on the edge location (e.g., fewer processing resources being available at consumer endpoint devices, than at a base station, than at a central office). However, the closer that the edge location is to the endpoint (e.g., user equipment (UE)), the more that space and power is often constrained. Thus, edge computing attempts to reduce the amount of resources needed for network services, through the distribution of more resources which are located closer both geographically and in network access time. In this manner, edge computing attempts to bring the compute resources to the workload data where appropriate, or, bring the workload data to the compute resources.

The following describes aspects of an edge cloud architecture that covers multiple potential deployments and addresses restrictions that some network operators or service providers may have in their own infrastructures. These include, variation of configurations based on the edge location (because edges at a base station level, for instance, may have more constrained performance and capabilities in a multi-tenant scenario); configurations based on the type of compute, memory, storage, fabric, acceleration, or like resources available to edge locations, tiers of locations, or groups of locations; the service, security, and management and orchestration capabilities; and related objectives to achieve usability and performance of end services. These deployments may accomplish processing in network layers that may be considered as “near edge”, “close edge”, “local edge”, “middle edge”, or “far edge” layers, depending on latency, distance, and timing characteristics.

Edge computing is a developing paradigm where computing is performed at or closer to the “edge” of a network, typically through the use of a compute platform (e.g., x86 or ARM compute hardware architecture) implemented at base stations, gateways, network routers, or other devices which are much closer to endpoint devices producing and consuming the data. For example, edge gateway servers may be equipped with pools of memory and storage resources to perform computation in real-time for low latency use-cases (e.g., autonomous driving or video surveillance) for connected client devices. Or as an example, base stations may be augmented with compute and acceleration resources to directly process service workloads for connected user equipment, without further communicating data via backhaul networks. Or as another example, central office network management hardware may be replaced with standardized compute hardware that performs virtualized network functions and offers compute resources for the execution of services and consumer functions for connected devices. Within edge computing networks, there may be scenarios in services which the compute resource will be “moved” to the data, as well as scenarios in which the data will be “moved” to the compute resource. Or as an example, base station compute, acceleration and network resources can provide services in order to scale to workload demands on an as needed basis by activating dormant capacity (subscription, capacity on demand) in order to manage corner cases, emergencies or to provide longevity for deployed resources over a significantly longer implemented lifecycle.

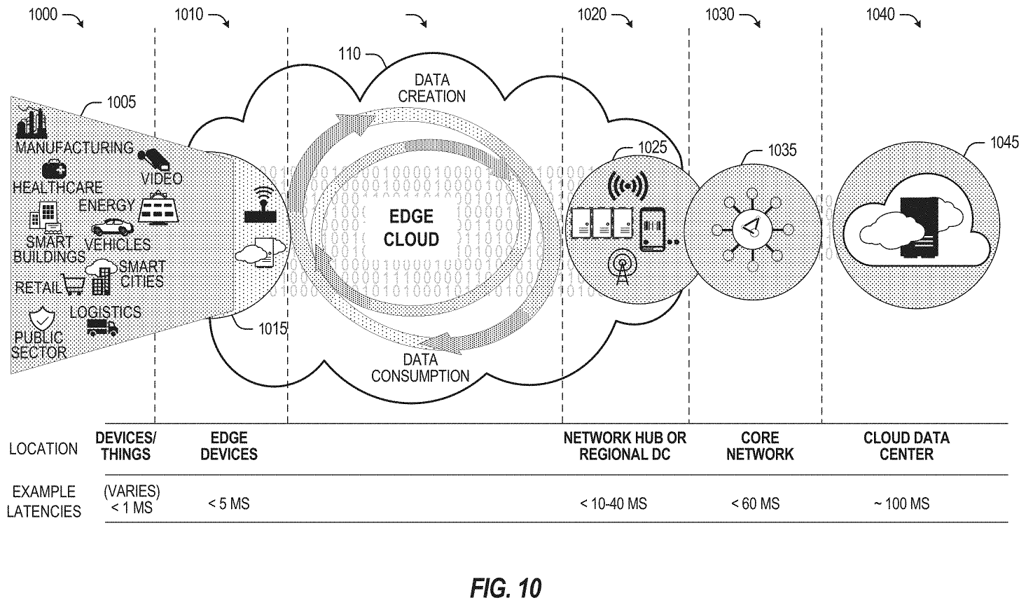

FIG. 10 illustrates operational layers among endpoints, an edge cloud, and cloud computing environments. Specifically, FIG. 10 depicts examples of computational use cases 1005, utilizing the edge cloud 910 among multiple illustrative layers of network computing. The layers begin at an endpoint (devices and things) layer 1000, which accesses the edge cloud 910 to conduct data creation, analysis, and data consumption activities. The edge cloud 910 may span multiple network layers, such as an edge devices layer 1010 having gateways, on-premise servers, or network equipment (nodes 1015) located in physically proximate edge systems; a network access layer 1020, encompassing base stations, radio processing units, network hubs, regional data centers (DC), or local network equipment (equipment 1025); and any equipment, devices, or nodes located therebetween (in layer 1012, not illustrated in detail). The network communications within the edge cloud 910 and among the various layers may occur via any number of wired or wireless mediums, including via connectivity architectures and technologies not depicted.

Examples of latency, resulting from network communication distance and processing time constraints, may range from less than a millisecond (ms) when among the endpoint layer 1000, under 5 ms at the edge devices layer 1010, to even between 10 to 40 ms when communicating with nodes at the network access layer 1020. Beyond the edge cloud 910 are core network 1030 and cloud data center 1040 layers, each with increasing latency (e.g., between 50-60 ms at the core network layer 1030, to 100 or more ms at the cloud data center layer). As a result, operations at a core network data center 1035 or a cloud data center 1045, with latencies of at least 50 to 100 ms or more, will not be able to accomplish many time-critical functions of the use cases 1005. Each of these latency values are provided for purposes of illustration and contrast; it will be understood that the use of other access network mediums and technologies may further reduce the latencies. In some examples, respective portions of the network may be categorized as “close edge”, “local edge”, “near edge”, “middle edge”, or “far edge” layers, relative to a network source and destination. For instance, from the perspective of the core network data center 1035 or a cloud data center 1045, a central office or content data network may be considered as being located within a “near edge” layer (“near” to the cloud, having high latency values when communicating with the devices and endpoints of the use cases 1005), whereas an access point, base station, on-premise server, or network gateway may be considered as located within a “far edge” layer (“far” from the cloud, having low latency values when communicating with the devices and endpoints of the use cases 1005). It will be understood that other categorizations of a particular network layer as constituting a “close”, “local”, “near”, “middle”, or “far” edge may be based on latency, distance, number of network hops, or other measurable characteristics, as measured from a source in any of the network layers 1000-1040.

The various use cases 1005 may access resources under usage pressure from incoming streams, due to multiple services utilizing the edge cloud. To achieve results with low latency, the services executed within the edge cloud 910 balance varying requirements in terms of: (a) Priority (throughput or latency) and Quality of Service (QoS) (e.g., traffic for an autonomous car may have higher priority than a temperature sensor in terms of response time requirement; or, a performance sensitivity/bottleneck may exist at a compute/accelerator, memory, storage, or network resource, depending on the application); (b) Reliability and Resiliency (e.g., some input streams need to be acted upon and the traffic routed with mission-critical reliability, where as some other input streams may be tolerate an occasional failure, depending on the application); and (c) Physical constraints (e.g., power, cooling and form-factor).

The end-to-end service view for these use cases involves the concept of a service-flow and is associated with a transaction. The transaction details the overall service requirement for the entity consuming the service, as well as the associated services for the resources, workloads, workflows, and business functional and business level requirements. The services executed with the “terms” described may be managed at each layer in a way to assure real time, and runtime contractual compliance for the transaction during the lifecycle of the service. When a component in the transaction is missing its agreed to SLA, the system as a whole (components in the transaction) may provide the ability to (1) understand the impact of the SLA violation, and (2) augment other components in the system to resume overall transaction SLA, and (3) implement steps to remediate.

Thus, with these variations and service features in mind, edge computing within the edge cloud 910 may provide the ability to serve and respond to multiple applications of the use cases 1005 (e.g., object tracking, video surveillance, connected cars, etc.) in real-time or near real-time, and meet ultra-low latency requirements for these multiple applications. These advantages enable a whole new class of applications (Virtual Network Functions (VNFs), Function as a Service (FaaS), Edge as a Service (EaaS), standard processes, etc.), which cannot leverage conventional cloud computing due to latency or other limitations.

However, with the advantages of edge computing comes the following caveats. The devices located at the edge are often resource constrained and therefore there is pressure on usage of edge resources. Typically, this is addressed through the pooling of memory and storage resources for use by multiple users (tenants) and devices. The edge may be power and cooling constrained and therefore the power usage needs to be accounted for by the applications that are consuming the most power. There may be inherent power-performance tradeoffs in these pooled memory resources, as many of them are likely to use emerging memory technologies, where more power requires greater memory bandwidth. Likewise, improved security of hardware and root of trust trusted functions are also required, because edge locations may be unmanned and may even need permissioned access (e.g., when housed in a third-party location). Such issues are magnified in the edge cloud 910 in a multi-tenant, multi-owner, or multi-access setting, where services and applications are requested by many users, especially as network usage dynamically fluctuates and the composition of the multiple stakeholders, use cases, and services changes.

At a more generic level, an edge computing system may be described to encompass any number of deployments at the previously discussed layers operating in the edge cloud 910 (network layers 1000-1040), which provide coordination from client and distributed computing devices. One or more edge gateway nodes, one or more edge aggregation nodes, and one or more core data centers may be distributed across layers of the network to provide an implementation of the edge computing system by or on behalf of a telecommunication service provider (“telco”, or “TSP”), internet-of-things service provider, cloud service provider (CSP), enterprise entity, or any other number of entities. Various implementations and configurations of the edge computing system may be provided dynamically, such as when orchestrated to meet service objectives.

Consistent with the examples provided herein, a client compute node may be embodied as any type of endpoint component, device, appliance, or other thing capable of communicating as a producer or consumer of data. Further, the label “node” or “device” as used in the edge computing system does not necessarily mean that such node or device operates in a client or agent/minion/follower role; rather, any of the peer linked nodes or devices in the edge computing system refer to individual entities, nodes, or subsystems which include discrete or connected hardware or software configurations to facilitate or use the edge cloud 910.

As such, the edge cloud 910 is formed from network components and functional features operated by and within edge gateway nodes, edge aggregation nodes, or other edge compute nodes among network layers 1010-1030. The edge cloud 910 thus may be embodied as any type of network that provides edge computing and/or storage resources which are proximately located to radio access network (RAN) capable endpoint devices (e.g., mobile computing devices, IoT devices, smart devices, etc.), which are discussed herein. In other words, the edge cloud 910 may be envisioned as an “edge” which connects the endpoint devices and traditional network access points that serve as an ingress point into service provider core networks, including mobile carrier networks (e.g., Global System for Mobile Communications (GSM) networks, Long-Term Evolution (LTE) networks, 5G/6G networks, etc.), while also providing storage and/or compute capabilities. Other types and forms of network access (e.g., Wi-Fi, long-range wireless, wired networks including optical networks) may also be utilized in place of or in combination with such 3GPP carrier networks.

The network components of the edge cloud 910 may be servers, multi-tenant servers, appliance computing devices, and/or any other type of computing devices. For example, the edge cloud 910 may include an appliance computing device that is a self-contained electronic device including a housing, a chassis, a case or a shell. In some circumstances, the housing may be dimensioned for portability such that it can be carried by a human and/or shipped. Example housings may include materials that form one or more exterior surfaces that partially or fully protect contents of the appliance, in which protection may include weather protection, hazardous environment protection (e.g., EMI, vibration, extreme temperatures), and/or enable submergibility. Example housings may include power circuitry to provide power for stationary and/or portable implementations, such as AC power inputs, DC power inputs, AC/DC or DC/AC converter(s), power regulators, transformers, charging circuitry, batteries, wired inputs and/or wireless power inputs. Example housings and/or surfaces thereof may include or connect to mounting hardware to enable attachment to structures such as buildings, telecommunication structures (e.g., poles, antenna structures, etc.) and/or racks (e.g., server racks, blade mounts, etc.). Example housings and/or surfaces thereof may support one or more sensors (e.g., temperature sensors, vibration sensors, light sensors, acoustic sensors, capacitive sensors, proximity sensors, etc.). One or more such sensors may be contained in, carried by, or otherwise embedded in the surface and/or mounted to the surface of the appliance. Example housings and/or surfaces thereof may support mechanical connectivity, such as propulsion hardware (e.g., wheels, propellers, etc.) and/or articulating hardware (e.g., robot arms, pivotable appendages, etc.). In some circumstances, the sensors may include any type of input devices such as user interface hardware (e.g., buttons, switches, dials, sliders, etc.). In some circumstances, example housings include output devices contained in, carried by, embedded therein and/or attached thereto. Output devices may include displays, touchscreens, lights, LEDs, speakers, I/O ports (e.g., USB), etc. In some circumstances, edge devices are devices presented in the network for a specific purpose (e.g., a traffic light), but may have processing and/or other capacities that may be utilized for other purposes. Such edge devices may be independent from other networked devices and may be provided with a housing having a form factor suitable for its primary purpose; yet be available for other compute tasks that do not interfere with its primary task. Edge devices include Internet of Things devices. The appliance computing device may include hardware and software components to manage local issues such as device temperature, vibration, resource utilization, updates, power issues, physical and network security, etc. Example hardware for implementing an appliance computing device is described in conjunction with FIG. D1B. The edge cloud 910 may also include one or more servers and/or one or more multi-tenant servers. Such a server may include an operating system and implement a virtual computing environment. A virtual computing environment may include a hypervisor managing (e.g., spawning, deploying, destroying, etc.) one or more virtual machines, one or more containers, etc. Such virtual computing environments provide an execution environment in which one or more applications and/or other software, code or scripts may execute while being isolated from one or more other applications, software, code or scripts.

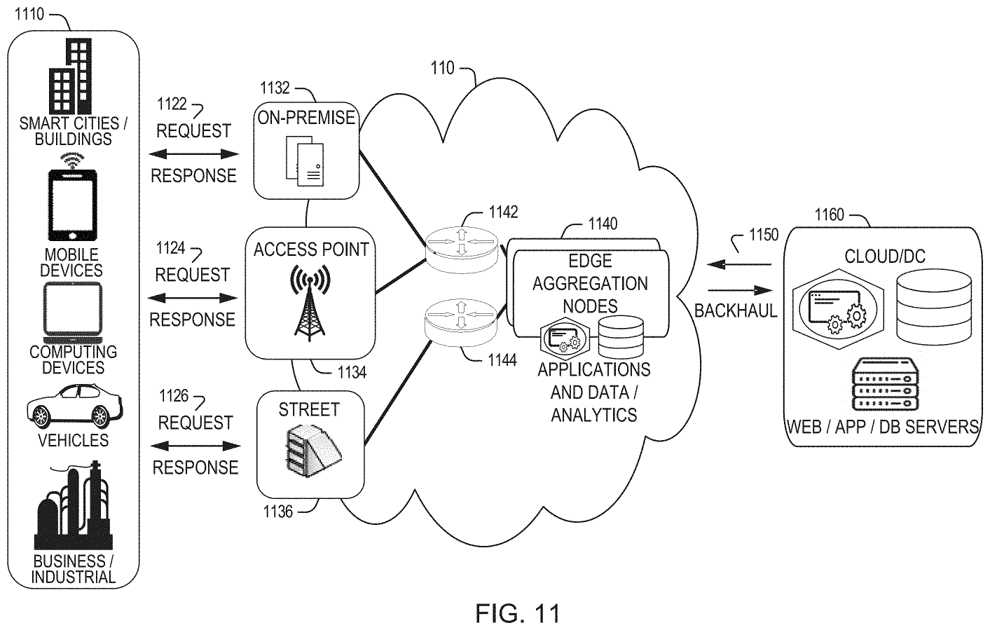

In FIG. 11, various client endpoints 1110 (in the form of mobile devices, computers, autonomous vehicles, business computing equipment, industrial processing equipment) exchange requests and responses that are specific to the type of endpoint network aggregation. For instance, client endpoints 1110 may obtain network access via a wired broadband network, by exchanging requests and responses 1122 through an on-premise network system 1132. Some client endpoints 1110, such as mobile computing devices, may obtain network access via a wireless broadband network, by exchanging requests and responses 1124 through an access point (e.g., cellular network tower) 1134. Some client endpoints 1110, such as autonomous vehicles may obtain network access for requests and responses 1126 via a wireless vehicular network through a street-located network system 1136. However, regardless of the type of network access, the TSP may deploy aggregation points 1142, 1144 within the edge cloud 910 to aggregate traffic and requests. Thus, within the edge cloud 910, the TSP may deploy various compute and storage resources, such as at edge aggregation nodes 1140, to provide requested content. The edge aggregation nodes 1140 and other systems of the edge cloud 910 are connected to a cloud or data center 1160, which uses a backhaul network 1150 to fulfill higher-latency requests from a cloud/data center for websites, applications, database servers, etc. Additional or consolidated instances of the edge aggregation nodes 1140 and the aggregation points 1142, 1144, including those deployed on a single server framework, may also be present within the edge cloud 910 or other areas of the TSP infrastructure.

FIG. 12 is a block diagram of an example processor platform 1200 structured to execute the instructions of FIG. 5 to implement the topology analyzer 110 of FIGS. 1 and/or 2. The processor platform 1200 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset or other wearable device, or any other type of computing device.

The processor platform 1200 of the illustrated example includes a processor 1212. The processor 1212 of the illustrated example is hardware. For example, the processor 1212 can be implemented by one or more integrated circuits, logic circuits, microprocessors, GPUs, DSPs, or controllers from any desired family or manufacturer. The hardware processor may be a semiconductor based (e.g., silicon based) device. In this example, the processor implements the example network information receiver 202, the example topology generator 204, the example reinforced learning analyzer 206, and the example topology transmitter 208.

The processor 1212 of the illustrated example includes a local memory 1213 (e.g., a cache). The processor 1212 of the illustrated example is in communication with a main memory including a volatile memory 1214 and a non-volatile memory 1216 via a bus 1218. The volatile memory 1214 may be implemented by Synchronous Dynamic Random Access Memory (SDRAM), Dynamic Random Access Memory (DRAM), RAMBUS® Dynamic Random Access Memory (RDRAM®) and/or any other type of random access memory device. The non-volatile memory 1216 may be implemented by flash memory and/or any other desired type of memory device. Access to the main memory 1214, 1216 is controlled by a memory controller.

The processor platform 1200 of the illustrated example also includes an interface circuit 1220. The interface circuit 1220 may be implemented by any type of interface standard, such as an Ethernet interface, a universal serial bus (USB), a Bluetooth® interface, a near field communication (NFC) interface, and/or a PCI express interface.

In the illustrated example, one or more input devices 1222 are connected to the interface circuit 1220. The input device(s) 1222 permit(s) a user to enter data and/or commands into the processor 1212. The input device(s) can be implemented by, for example, an audio sensor, a microphone, a camera (still or video), a keyboard, a button, a mouse, a touchscreen, a track-pad, a trackball, isopoint and/or a voice recognition system.

One or more output devices 1224 are also connected to the interface circuit 1220 of the illustrated example. The output devices 1224 can be implemented, for example, by display devices (e.g., a light emitting diode (LED), an organic light emitting diode (OLED), a liquid crystal display (LCD), a cathode ray tube display (CRT), an in-place switching (IPS) display, a touchscreen, etc.), a tactile output device, a printer and/or speaker. The interface circuit 1220 of the illustrated example, thus, typically includes a graphics driver card, a graphics driver chip and/or a graphics driver processor.

The interface circuit 1220 of the illustrated example also includes a communication device such as a transmitter, a receiver, a transceiver, a modem, a residential gateway, a wireless access point, and/or a network interface to facilitate exchange of data with external machines (e.g., computing devices of any kind) via a network 1226. The communication can be via, for example, an Ethernet connection, a digital subscriber line (DSL) connection, a telephone line connection, a coaxial cable system, a satellite system, a line-of-site wireless system, a cellular telephone system, etc.

The processor platform 1200 of the illustrated example also includes one or more mass storage devices 1228 for storing software and/or data. Examples of such mass storage devices 1228 include floppy disk drives, hard drive disks, compact disk drives, Blu-ray disk drives, redundant array of independent disks (RAID) systems, and digital versatile disk (DVD) drives.

The machine executable instructions 1232 of FIG. 5 may be stored in the mass storage device 1228, in the volatile memory 1214, in the non-volatile memory 1216, and/or on a removable non-transitory computer readable storage medium such as a CD or DVD.

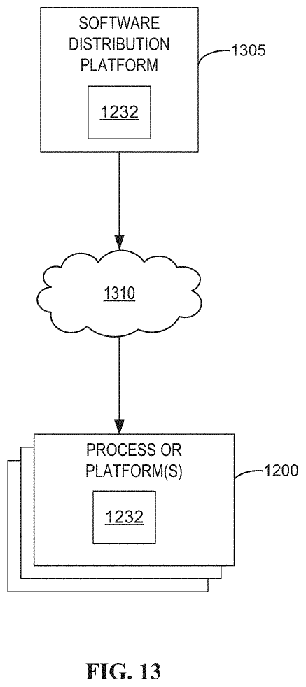

A block diagram illustrating an example software distribution platform 1305 to distribute software such as the example computer readable instructions 1232 of FIG. 12 to third parties is illustrated in FIG. 13. The example software distribution platform 1305 may be implemented by any computer server, data facility, cloud service, etc., capable of storing and transmitting software to other computing devices. The third parties may be customers of the entity owning and/or operating the software distribution platform. For example, the entity that owns and/or operates the software distribution platform may be a developer, a seller, and/or a licensor of software such as the example computer readable instructions 1232 of FIG. 9. The third parties may be consumers, users, retailers, OEMs, etc., who purchase and/or license the software for use and/or re-sale and/or sub-licensing. In the illustrated example, the software distribution platform 1305 includes one or more servers and one or more storage devices. The storage devices store the computer readable instructions 1232, which may correspond to the example computer readable instructions of FIG. 5, as described above. The one or more servers of the example software distribution platform 1305 are in communication with a network 1310, which may correspond to any one or more of the Internet and/or any other network. In some examples, the one or more servers are responsive to requests to transmit the software to a requesting party as part of a commercial transaction. Payment for the delivery, sale and/or license of the software may be handled by the one or more servers of the software distribution platform and/or via a third-party payment entity. The servers enable purchasers and/or licensors to download the computer readable instructions 1232 from the software distribution platform 1305. For example, the software, which may correspond to the example computer readable instructions of FIG. 5, may be downloaded to the example processor platform 1200, which is to execute the computer readable instructions 1232 to implement the topology analyzer 110. In some example, one or more servers of the software distribution platform 1305 periodically offer, transmit, and/or force updates to the software (e.g., the example computer readable instructions 1232 of FIG. 12) to ensure improvements, patches, updates, etc. are distributed and applied to the software at the end user devices.

While the instructions 1232 are shown in both the software distribution platform 1305 and the processor platform(s) 1200 in the illustrated example, the instructions 1232 may be in different forms in both locations. For example, the instructions 1232 stores in the software distribution platform 1305 may be compressed, while the instructions 1232 at the processor platform(s) may be decompressed (e.g., in a form set for execution).

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

From the foregoing, it will be appreciated that example methods, apparatus and articles of manufacture have been disclosed that efficiently compute optimized topologies for a network such as a mesh network. The disclosed methods, apparatus and articles of manufacture improve the efficiency of using a computing device by computing the optimized topologies more efficiently than other algorithms such as dynamic programming while obtaining results that are only minimally less optimized. The disclosed methods, apparatus and articles of manufacture are accordingly directed to one or more improvement(s) in the functioning of a computer.

Example methods, apparatus, systems, and articles of manufacture to mitigate locks in real-time computing environments are disclosed herein. Further examples and combinations thereof include the following:

Example methods, apparatus, systems, and articles of manufacture to determine topologies for networks are disclosed herein. Further examples and combinations thereof include the following:

Example 1 includes a non-transitory computer readable medium comprising instructions that, when executed, cause a machine to at least determine link capacities for a plurality of links between nodes of a network, determine a maximum number of children of the peer linked nodes, determine a maximum number of parents of the peer linked nodes, and utilize reinforcement learning to determine a subset of the plurality of links to be activated in the network based on the link capacities, the maximum number of children, and the maximum number of parents.

Example 2 includes the non-transitory computer readable medium of example 1, wherein the network is an integrated access backhaul network.

Example 3 includes the non-transitory computer readable medium of example 2, wherein the peer linked nodes include an integrated access backhaul donor and a plurality of integrated access backhaul nodes.

Example 4 includes the non-transitory computer readable medium of examples 1-3, wherein one of the peer linked nodes includes a neural processor for executing a reinforcement learning algorithm.

Example 5 includes the non-transitory computer readable medium of example 1-4, wherein the reinforcement learning learns neural network weights.

Example 6 includes the non-transitory computer readable medium of example 1-5, wherein the reinforcement learning is defined over a graph with graph embedding.

Example 7 includes the non-transitory computer readable medium of example 1-6, wherein the link capacities are determined based on reference signal received power measurements of the links between the peer linked nodes.

Example 8 includes the non-transitory computer readable medium of example 1-7, wherein a goal of the reinforcement learning is to maximize a total network capacity of the network.

Example 9 includes the non-transitory computer readable medium of example 8, wherein the total network capacity is a sum of node scores for each of the peer linked nodes.

Example 10 includes the non-transitory computer readable medium of example 1-9, wherein the instructions, when executed, cause the machine to transmit information about the subset of the plurality of links to the peer linked nodes.

Example 11 includes an apparatus comprising a network information receiver to determine link capacities for a plurality of links between nodes of a network, determine a maximum number of children of the peer linked nodes, and determine a maximum number of parents of the peer linked nodes, and a reinforced learning analyzer to utilize reinforcement learning to determine a subset of the plurality of links to be activated in the network based on the link capacities, the maximum number of children, and the maximum number of parents.

Example 12 includes the apparatus of example 11, wherein the network is an integrated access backhaul network.

Example 13 includes the apparatus of example 12, wherein the peer linked nodes include an integrated access backhaul donor and a plurality of integrated access backhaul nodes.

Example 14 includes the apparatus of example 11-13, wherein the reinforced learning analyzer includes a neural processor for executing a reinforcement learning algorithm.

Example 15 includes the apparatus of example 11-14, wherein the reinforcement learning learns neural network weights.

Example 16 includes the apparatus of example 11-15, wherein the reinforcement learning is defined over a graph with graph embedding.

Example 17 includes the apparatus of example 11-16, wherein the link capacities are determined based on reference signal received power measurements of the links between the peer linked nodes.

Example 18 includes the apparatus of example 11-17, wherein a goal of the reinforcement learning is to maximum a total network capacity of the network.

Example 19 includes the apparatus of example 18, wherein the total network capacity is a sum of node scores for each of the peer linked nodes.

Example 20 includes the apparatus of example 11-9, further including a topology transmitter to transmit information about the subset of the plurality of links to the peer linked nodes.

Example 21 includes a method to determine topologies for networks, the method comprising determining link capacities for a plurality of links between nodes of a network, determining a maximum number of children of the peer linked nodes, determining a maximum number of parents of the peer linked nodes, and utilizing reinforcement learning to determine a subset of the plurality of links to be activated in the network based on the link capacities, the maximum number of children, and the maximum number of parents.

Example 22 includes the method of example 21, wherein the network is an integrated access backhaul network.

Example 23 includes the method of example 22, wherein the peer linked nodes include an integrated access backhaul donor and a plurality of integrated access backhaul nodes.

Example 24 includes the method of example 21-23, wherein one of the peer linked nodes includes a neural processor for executing a reinforcement learning algorithm.

Example 25 includes the method of example 21-24, wherein the reinforcement learning learns neural network weights.

Example 26 includes the method of example 21-25, wherein the reinforcement learning is defined over a graph with graph embedding.

Example 27 includes the method of example 21-26, wherein the link capacities are determined based on reference signal received power measurements of the links between the peer linked nodes.

Example 28 includes the method of example 21-27, wherein a goal of the reinforcement learning is to maximum a total network capacity of the network.

Example 29 includes the method of example 28, wherein the total network capacity is a sum of node scores for each of the peer linked nodes.

Example 30 includes the method of example 21-29, further including transmitting information about the subset of the plurality of links to the peer linked nodes.

Example 31 is an edge computing gateway, comprising processing circuitry to perform any of Examples 21-30.

Example 32 is a wireless access point, comprising a network interface card and processing circuitry to perform any of Examples 21-30.

Example 33 is a computer-readable medium comprising instructions to perform any of Examples 21-30.

The following claims are hereby incorporated into this Detailed Description by this reference, with each claim standing on its own as a separate embodiment of the present disclosure.

What is claimed is:

1. A non-transitory computer readable medium comprising instructions that, when executed, cause a machine to at least:
determine link capacities for a plurality of links between peer linked nodes of a network;
determine a maximum number of children of the peer linked nodes;
determine a maximum number of parents of the peer linked nodes; and
utilize reinforcement learning to determine a subset of the plurality of links to be activated in the network based on the link capacities, the maximum number of children, and the maximum number of parents.

2. The non-transitory computer readable medium of claim 1, wherein the network is an integrated access backhaul network.

3. The non-transitory computer readable medium of claim 2, wherein the peer linked nodes include an integrated access backhaul donor and a plurality of integrated access backhaul nodes.

4. The non-transitory computer readable medium of claim 1, wherein one of the peer linked nodes includes a neural processor for executing a reinforcement learning algorithm.

5. The non-transitory computer readable medium of claim 1, wherein the reinforcement learning learns neural network weights.

6. The non-transitory computer readable medium of claim 1, wherein the reinforcement learning is defined over a graph with graph embedding.

7. The non-transitory computer readable medium of claim 1, wherein the link capacities are determined based on reference signal received power measurements of the links between the peer linked nodes.

8. The non-transitory computer readable medium of claim 1, wherein a goal of the reinforcement learning is to maximize a total network capacity of the network.

9. The non-transitory computer readable medium of claim 8, wherein the total network capacity is a sum of node scores for each of the peer linked nodes.

10. The non-transitory computer readable medium of claim 1, wherein the instructions, when executed, cause the machine to transmit information about the subset of the plurality of links to the peer linked nodes.

11. An apparatus comprising:
a network information receiver to:
determine link capacities for a plurality of links between peer linked nodes of a network;
determine a maximum number of children of the peer linked nodes; and
determine a maximum number of parents of the peer linked nodes; and
a reinforced learning analyzer to utilize reinforcement learning to determine a subset of the plurality of links to be activated in the network based on the link capacities, the maximum number of children, and the maximum number of parents.

12. The apparatus of claim 11, wherein the network is an integrated access backhaul network.

13. The apparatus of claim 12, wherein the peer linked nodes include an integrated access backhaul donor and a plurality of integrated access backhaul nodes.

14. The apparatus of claim 11, wherein the reinforced learning analyzer includes a neural processor for executing a reinforcement learning algorithm.

15. The apparatus of claim 11, wherein the reinforcement learning learns neural network weights.

16. The apparatus of claim 11, wherein the reinforcement learning is defined over a graph with graph embedding.

17. The apparatus of claim 11, wherein the link capacities are determined based on reference signal received power measurements of the links between the peer linked nodes.

18. The apparatus of claim 11, wherein a goal of the reinforcement learning is to maximum a total network capacity of the network.

19. The apparatus of claim 18, wherein the total network capacity is a sum of node scores for each of the peer linked nodes.

20. The apparatus of claim 11, further including a topology transmitter to transmit information about the subset of the plurality of links to the peer linked nodes.

21. A system comprising:
memory;
a wireless access point;
a processor to execute instructions to:
determine link capacities for a plurality of links between peer linked nodes of a network, the peer linked nodes including the wireless access point;
determine a maximum number of children of the peer linked nodes;
determine a maximum number of parents of the peer linked nodes; and
utilize reinforcement learning to determine a subset of the plurality of links to be activated in the network based on the link capacities, the maximum number of children, and the maximum number of parents.

22. The system of claim 21, wherein the network is an integrated access backhaul network.

23. The system of claim 22, wherein the peer linked nodes include an integrated access backhaul donor and a plurality of integrated access backhaul nodes.

24. The system of claim 21, wherein one of the peer linked nodes includes a neural processor for executing a reinforcement learning algorithm.

25. The system of claim 21, wherein the reinforcement learning learns neural network weights.
